(19) United States
(12) Patent Application Publication
(10) Pub. No.: US 2026/0339456 A1
(43) Pub. Date: Oct. 29, 2026

(54) Portable Digital Display Devices And Methods For Operating A Portable Digital Display Device

(71) Applicant: Siemens Aktiengesellschaft, München (DE)

(72) Inventors: Raphaela Groten, Aachen (DE); Rebecca Johnson, München (DE)

(73) Assignee: Siemens Aktiengesellschaft, München (DE)

(21) Appl. No.: 19/107,319

(22) PCT Filed: Aug. 8, 2023
(86) PCT No.: PCT/EP2023/071931

§ 371 Date: Feb. 27, 2025

(30) Foreign Application Priority Data
Aug. 29, 2022 (EP) 22192669.4

(51) Int. Cl. G06F 3/041; G06F 3/044; G06F 3/04883; G06F 3/14; G06V 10/70; G06V 30/262; G06V 30/32

(52) U.S. Cl. CPC G06F 3/04166; G06F 3/04883; G06F 3/14; G06V 10/768; G06V 30/274; G06V 30/32; G06F 3/044; G06F 2203/04102; G06F 2203/04104; G06F 2203/04807

(57) ABSTRACT

Embodiments of the teachings herein include a portable digital display device. An example includes: a display with a display area; a first module to detect semantic content and/or a control indication; a first interface to acquire displayable digital content from a source; an energy storage; a second interface connected to the energy storage to allow recharging the energy storage; and an adjustment mechanism providing adjustment between a first state having a first footprint and a second state having a second footprint. The first footprint corresponds to the display area. The display area is fixable vertically and/or horizontally as a so-called whiteboard and is usable at the same time by a plurality of people. The second footprint renders the display device transportable.

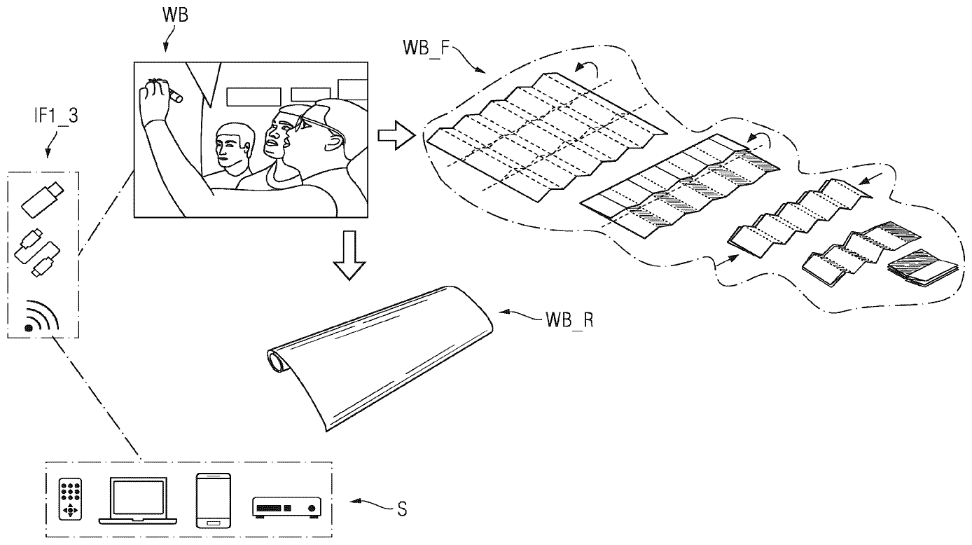

### CROSS-REFERENCE TO RELATED APPLICATIONS

This application is a U.S. National Stage Application of International Application No. PCT/EP 2023/071931 filed Aug. 8, 2023, which designates the United States of America, and claims priority to EP Application No. 22192669.4 filed Aug. 29, 2022, the contents of which are hereby incorporated by reference in their entirety.

### TECHNICAL FIELD

The present disclosure relates to portable digital display devices. Various embodiments of the teachings herein include systems and/or methods for a portable digital display device.

### BACKGROUND

Cooperative work, for example, on so-called whiteboards or flip charts, is known. In particular to provide a creative environment, also using them outdoors is known in particular in the case of flipcharts. However, these are only usable in the horizontal and the weather, in particular wind and moisture, make the usage only possible under specific conditions. If one wishes to maintain a distance between the cooperating persons, for example, because of protection from infection, or if one wishes a better view of the contents, larger flipcharts have to be provided or a rigid whiteboard has to be transported outside. The latter would not be as sensitive with respect to the weather and it could also be laid down, for example, so that the people could distribute themselves with spacing around the board, but it would simply be too bulky, like the enlarged flipchart as well, for temporary storage but also transport to the outside. This also applies for digitizing flipcharts or touch-sensitive whiteboards based on LED technology, which do enable content on the displays to be digitized, but are not considered for transport outside due to their weight and size. Moreover, both of these require energy, which makes a power grid connection necessary.

Up to this point, no technical solution is known which Satisfactorily resolves the mentioned disadvantages.

### SUMMARY

The teachings of the present disclosure include systems and/or methods which overcome the disadvantages of the prior art; in particular technical solutions which improves cooperative work, in particular in the outdoor area. For example, some embodiments include a portable digital display device, designed such that a) a first state having a first dimension of a footprint and a second state having a second footprint is adoptable by the display device, b) in the first state, the footprint essentially corresponds to the display area, wherein in this state at least one display of digital content and a detection carried out by a first module at least of semantic content and/or at least of a control option, preferably in each case by evaluation of a module of detected touches of the surface, can be carried out, and wherein the size of the display area is designed such that the display area is fixable vertically and/or horizontally as a so-called whiteboard and is usable at the same time by a plurality of people, c) in the second state, the footprint is dimensioned such that the display device is transportable, in particular with one hand and/or in a carrier bag, d) the display device is configured having a first interface at least for acquiring displayable digital content provided by a source, e) it is designed having an energy storage device and a second interface functionally connected to the energy storage device such that the energy storage device is rechargeable via the second interface device.

In some embodiments, the touch detection is configured by a design of the surface of the display device for the so-called touch functionality, in particular the multitouch functionality.

In some embodiments, the detection is configured by an integrated speech recognition function.

In some embodiments, the first interface is designed as a unidirectional image interface, for example according to the HDMI standard, and/or as a bidirectional wired communication interface, for example a so-called USB interface, and/or a bidirectional wireless communication interface, for example a standard according to the WLAN, Bluetooth, and/or a near field communication standard, such as the NFC standard.

In some embodiments, the second interface is designed as a USB interface, in particular configured as usable at the same time as the first interface.

In some embodiments, the display device is designed as a so-called e-paper, wherein the transition from the first state to the second state can be carried out by rolling and/or folding the e-paper.

In some embodiments, the first module is designed such that it is designed for recognizing handwritten and/or in particular spoken words and upon recognition of semantic contents subjects these to a conversion into a digital datum displayable at least in one text format and upon nonrecognition subjects these to a conversion into a digital datum interpreted as a graphic input and displayable as an image.

In some embodiments, the first module is designed such that it carries out the control of the display device such that a) it is made capable of recognizing at least one control character from detected semantic contents, b) it detects inputs marked by the at least one control character as a command and/or selection, c) it carries out at least one state change assigned to the command or the selection of at least parts of the display device and/or displayed content.

In some embodiments, the display device has a third interface, which is designed such that in the first state it presents wirelessly transmitted electromagnetic, in particular optical signals at least as an interpretable movement incident within the display area of a remote signal source to the first module for recognizing semantic contents.

As another example, some embodiments include a method for operating one or more of the portable digital display devices described herein.

As another example, some embodiments include an arrangement for carrying out one or more of the methods described herein.

### BRIEF DESCRIPTION OF THE DRAWINGS

Further advantages and details of the teachings herein are be explained on the basis of the exemplary embodiments illustrated in the single figure.

The figure schematically shows a detection and transfer of symbols from a 2D model into a 3D model on the basis of the example of fire alarm systems.

The exemplary embodiments explained hereinafter in the figure are example embodiments and refinements of the teachings herein and do not limit the scope of the disclosure.

### DETAILED DESCRIPTION

If not indicated otherwise in the following description, the terms “carry out”, “implement”, “transform”, “transfer”, “calculate”, “computer-based”, “compute”, “establish”, “generate”, “configure”, “reconstruct”, “ascertain”, “detect”, and the like refer to actions and/or processes and/or processing steps which change and/or generate data and/or convert the data into other data, wherein the data are represented or can exist in particular as physical variables, for example, as electrical pulses. In particular, the term “computer” is to be interpreted as broadly as possible, in particular to cover all electronic devices having data processing properties. Computers can therefore be, for example, personal computers, servers, storage-programmable programmable logic controllers (PLC), handheld computer systems, pocket PC devices, mobile wireless devices and other communication devices, which can process data in a computer-based manner, processors, and other electronic devices for data processing. “Computer-based” or “computer-assisted” can be understood, for example, as an implementation of the method in which in particular a processor carries out at least one method step of the method.

A processor can be understood, for example, as a machine or an electronic circuit. A processor can in particular be a central processing unit (CPU), a microprocessor, or a microcontroller. A processor can also be, for example, an IC (integrated circuit), in particular an FPGA (field-programmable gate array) or an ASIC (application-specific integrated circuit), or a DSP (digital signal processor) or a graphics processor GPU (graphic processing unit). A processor can also be understood as a virtualized processor, a virtual machine, or a soft CPU. It can also be, for example, a programmable processor, which is equipped with configuration steps for carrying out one or more of the mentioned methods or is configured using configuration steps such that the programmable processor implements the features, the component, the modules, or other aspects and/or partial aspects of the disclosure.

A “memory unit” or a “memory module” and the like can be understood, for example, as a volatile memory in the form of working memory (random-access memory, RAM) or a permanent memory such as a hard drive or a data carrier and a combination of one or more of these elements to form a so-called cloud.

A “module” can be understood, for example, as at least one processor and/or at least one memory unit for storing program commands, which are connected in a functionally interacting manner physically at one location, for example a part of a printed circuit board, or also are connected in a functionally interacting manner distributed on multiple entities of a network. For example, the processor is especially configured for the purpose of carrying out the program commands such that the processor executes functions in order to implement or realize the method according to the invention or a step of the method according to the invention.

In an example portable digital display device incorporating teachings of the present disclosure:
a) a first state having a first dimension of a footprint and a second state having a second footprint is adoptable by the display device,
b) in the first state, the footprint essentially corresponds to the display area, wherein in this state at least one display of digital content and a detection carried out by a first module at least of semantic content and/or at least of a control option, preferably in each case by evaluation of a module of detected touches of the surface, can be carried out, and wherein the size of the display area is designed such that the display area is fixable vertically and/or horizontally as a so-called whiteboard and is usable at the same time by a plurality of people,
c) in the second state, the footprint is dimensioned such that the display device is transportable, in particular with one hand and/or in a carrier bag,
d) the display device is configured having a first interface at least for acquiring displayable digital content provided by a source, in particular a computer and/or memory device,
e) the display device is designed having an energy storage device and a second interface functionally connected to the energy storage device such that the energy storage device is rechargeable via the second interface device.

An example method incorporating: teachings of the present disclosure is suitable for operating a portable digital display device and/or its refinements.

The methods described herein may provide individual or combined steps which help here to implement the advantages of the portable digital display devices described herein, for example, in that it controls the individual functional units and/or the entirety of the functional units according to the portable digital display device and the refinements thereof or provides the functions. The method also incorporates here individual steps, required for operating the display device, of any devices, for example, external devices which are possible and/or required by refinements and interact with the portable digital display device. The method thus relates to the arrangements, which operate the portable digital display device to carry out one or more of the methods and therefore implements the advantages of the portable digital display device, whether solely by the display device or in conjunction with further devices. In some embodiments, the method relates to computer-implemented processes, for example, distributed on one H more units of the arrangement and carrying out all or individual steps of the method and influencing technical states of individual or all participating units.

In some embodiments, the touch detection is configured by a design of the surface of the display device for the so-called touch functionality, in particular the multitouch functionality. Using this refinement, it becomes possible to carry out handwritten inputs directly, possibly for more precise line control using a special, in particular capacitive pen, on the display device and receive immediate visual feedback. Furthermore, fields which represent menu points and/or virtual switch surfaces can be used by touch to control states and/or functions of the display device and/or properties of the displayed objects.

In some embodiments, the detection is configured by an integrated speech recognition function. Using this refinement, for example, commands can be detected which cause a state change of the display and/or function of the display device. Furthermore, semantic contents can thus also be detected and displayed. These will generally be speech contents, but it is also conceivable to select graphic contents with the aid of commands and have them displayed and/or changed by the display device-likewise placed and/or dimensioned by commands. A further advantage is that distance can be maintained between the actors during cooperative work, for example, to retain the free view of the display device but also to take into consideration health aspects, such as protection from infection.

In some embodiments, the first interface is designed as a unidirectional image interface, for example, according to the HDMI standard, and/or as a bidirectional wired communication interface, for example, a so-called USB interface, and/or a bidirectional wireless communication interface, for example, according to the WLAN, Bluetooth, and/or a near field communication standard, such as the NFC standard. For example, to minimize the resource requirements and the dimensions of the display device, its functionality can substantially only be reduced to the display of contents, this refinement is then to be viewed as an alternative design to a more complex design, in particular having computer architecture, in particular if a unidirectional image interface is used. In the latter design, this refinement can offer additional, thus supplementary functionalities, in particular if bidirectional communication interfaces are used. In this way, all routine, in particular computer-implemented interactions with external devices, such as computers or computer networks and memory devices are possible. If this communication interface is designed as wireless, a further improvement is achieved with respect to the basic concept of making work mobile and cooperative while simultaneously ensuring required or sufficient distance.

In some embodiments, the second interface is designed as a USB interface, in particular configured as usable at the same time as the first interface. By combination of as many functions as possible in an interface, the resource requirements are reduced; furthermore degrees of freedom, in particular with respect to the dimensioning and/or the design of the portable digital display device and of the space for other functional units, such as further interfaces, are increased.

In some embodiments, the display device is designed as so-called e-paper, wherein the transition from the first state to the second state can be carried out by rolling and/or folding the e-paper. A whiteboard for mobile use is provided by this refinement, which is suitable above all for use outdoors due to the properties of e-paper or the use of e-ink technology with respect to visibility and contrast with brightness of similar display technologies, since even direct incident sunlight has little influence on the visibility of the displayed content. Furthermore, these technologies are outstandingly suitable for longer use without a power source with respect to the power consumption. They also enable a very thin, very mechanically flexible embodiment of display screens, so that it can be designed in a simple manner for rolling up or folding up the portable digital display device according to the invention. The rolling up or folding up in turn increases the level of mobility, because the size of the display can be reduced in the second state enough that it can be carried in routine carrier bags and/or using one hand. For use, it can then be unfolded or unrolled again and then attached horizontally, for example, on a table or the ground, or vertically, for example, on an exterior wall or a corresponding display stand.

In some embodiments, the first module is designed such that it is designed for recognizing handwritten and/or in particular spoken words and upon recognition of semantic contents, subjects these to a conversion into a digital datum displayable at least in one text format and upon nonrecognition subjects these to a conversion into a digital datum interpreted as a graphic input and displayable as an image. Using this refinement, the display device itself is made capable of converting analog inputs into digital representations with the same semantic meaning, but possibly in different formats. Due to this provided conversion, it is then easily possible in a second step to select a routine digital file format in which the semantic content can be fixed, edited, and/or stored and possibly transmitted or made transportable for use by other devices. Furthermore, the recognizability of the content for participants in the cooperative work is improved because individual manifestations of the inputs are equalized by standardized character formats.

In some embodiments, the first module is designed such that it carries out the control of the display device such that
a) it is made capable of recognizing at least one control character from detected semantic contents,
b) detects inputs marked by the at least one control character as a command and/or selection,
c) carries out at least one state change, assigned to the command or the selection, of at least parts of the display device and/or displayed content.

This refinement thus enables input contents to be given special meaning, in order to obtain a functionality similar to markup language, such as XML or HTML, thus structuring of texts and/or other contents, commands for controlling the display and/or the display devices themselves. In this way, the portable digital display device can be controlled in a flexible manner, without having to display virtual switching surfaces, for example, which take space for contents, or having to provide internal or external MMI interfaces for this purpose or possibly solely reducing these to an on and/or off switch. Self-evidently, this refinement is also usable for acoustic inputs in that markup-like character sequences or predefined commands which are more easily semantically comprehensible are spoken, detected, and executed.

In some embodiments, the display device has a third interface, which is designed such that in the first state, it presents wirelessly transmitted electromagnetic, in particular optical signals at least as a movement interpretable as incident within the display area of a remote signal source to the first module for recognizing semantic contents. Using this refinement, handheld devices emitting directed electromagnetic radiation, such as infrared, Bluetooth, WLAN, or laser, such as laser pointers or remote controls are usable for the input of semantic contents. The surface could use, for example, light spots of incident laser pointers for tracking a line traverse, thus an input. A silent input from a distance is thus possible. Movements of remote controls or corresponding manual devices containing transmission modules corresponding to the mentioned technologies, such as mobile telephones, can similarly and more complexly also hereby be used for input, as is known, for example, in the case of remote controls connected via WLAN to televisions for controlling a cursor.

The following exemplary embodiments only show exemplary possible implementations, in particular how those implementations of the teachings of the present disclosure could appear, since it is impossible and also not expedient or necessary for the comprehension of the invention to mention all of these possible implementations.

A whiteboard WB can be seen, which is used by multiple people, thus in cooperation. According to this embodiment, the input can take place by hand, by means of a so-called touch pen, and/or using one finger or multiple fingers. However, a touch pen input will be preferred in the context of infection protection measures.

In some embodiments, contactless inputs can also be implemented, for example, by speech input or movement detection of devices emitting electromagnetic radiation such as radio transmission/radio reception devices, in particular designed according to the WLAN or Bluetooth radio standard, as are to be found in smart phones, computers, and remote controls, or laser or infrared radiators, which are to be found in laser pointers or likewise in remote controls.

The illustrated whiteboard WB is an e-paper display dimensioned to a size of a typical whiteboard. I.e. presentations can readily be used outside independently of direct incident sunlight. It also has the advantage over, for example, LED displays, which have become available in the meantime in large sizes, thus whiteboard dimensions, and also have multitouch capability, which also permits cooperation between multiple actors, that it is easy to transport, offers good contrast, and at the same time has very low energy consumption.

In order to secure contents which have been input or to display external contents or permit a control, the whiteboard according to the invention can integrate one or more interfaces IF1_3. These can be wired and can ensure, for example, communication and/or energy supply according to the USB-C standard and/or can also be designed as wireless for communication of one of the radio standards known for a data exchange, such as WLAN, Bluetooth, or NFC.

Therefore, according to the shown embodiment, arbitrary sources can be connected for the display or also for control. The need for circuits and the power consumption in the display according to the invention can therefore be kept low, for example. However, there are therefore also diverse possibilities for storing the representation on the display. For this purpose, the whiteboard is made capable of digitizing the contents, possibly putting them into a file format for exchange. This functionality can also be partially or entirely provided in this case, for example, via the mentioned interfaces S, using devices connected to the whiteboard, for example in which a computer program product is installed on the device and this device has the functional units for the methods described herein, such as modules and interfaces IF1_3.

Furthermore, the mechanical flexibility and design of the teachings herein are schematically shown on the basis of two exemplary embodiments in the figure. A foldable variant of the whiteboard WB_F is shown to the right of the whiteboard. It can be seen how, for example, folding can be carried out. For this purpose, the foldable whiteboard could be prepared so that the edges for the folding are predetermined and, for example, folding known from folding maps can be implemented. Such a folded whiteboard WB_F can readily be taken in the hand or put into a bag, so that a transport is enormously simplified and outdoor use can easily be prepared for and carried out. Of course, the disclosure is not restricted to such folding. A few folds are also sufficient and/or it can also be designed without preparation, thus as completely freely foldable.

A second whiteboard WB_R characterized by its ability to be rolled up is shown below the schematically shown cooperative work. This can be transported easily while rolled up like known advertising displays, wherein it is somewhat bulkier than the foldable variant WB_F, but the light weight of the e-paper also makes it transportable in one hand in this form. A tubular container known from architecture could be used as a transport container, for example.

In these embodiments, the described components of the embodiments each represent individual features to be considered independently one another, which each also refine the embodiments independently of one another and therefore are also to be viewed individually or in a combination other than that shown. Furthermore, the described embodiments can also be supplemented by further features already described.

In other words, the embodiments integrate individual technical solutions found by considerations into a flexible unit achieving the objects described herein, which is provided, for example, as in the exemplary embodiment shown by a portable, foldable and/or rollable mobile e-paper display, which is therefore usable as a digital white paper or whiteboard and according to one refinement can also be designed as multitouch-capable and can reproduce various data formats, such as pdf, doc, txt, rtf, bmp, and/or ppt. It is sufficiently large in the unrolled or unfolded state that multiple people can work thereon, when it lies, for example, on a table or another flat surface, such as a floor, or is attached to a wall or a suitable stand.

In addition, at least one interface is available, for example to desktop computers and mobile terminals, in order to enable a data exchange. For an export of the data in the form of text and image, which are displayed on the e-paper according to the invention according to the exemplary embodiment, the arrangement can, according to refinements, also have a handwriting and/or image recognition function, which then transforms these contents into typical file formats for transport to other devices, so that they can be passed on.

Although the disclosure was illustrated and described in more detail by exemplary embodiments, the scope thereof is not restricted by the disclosed examples and other variations can be derived therefrom by a person skilled in the art, which fall under the scope of protection defined by the claims without departing from the scope of protection of the disclosure.

What is claimed is:

1. A portable digital display device comprising:
a display with a display area;
a first module to detect semantic content and/or a control indication;
a first interface to acquire displayable digital content from a source;
an energy storage;
a second interface connected to the energy storage to allow recharging the energy storage; and
an adjustment mechanism providing adjustment between first state having a first footprint and a second state having a second footprint;
wherein the first footprint corresponds to the display area;
wherein the display area is fixable vertically and/or horizontally as a so-called whiteboard and is usable at the same time by a plurality of people;
where in the second footprint renders the display device transportable.

2. The portable digital display device as claimed in claim 1, wherein a surface of the display provides touch detection.

3. The portable digital display device as claimed in claim 1, wherein the detection includes an integrated speech recognition function.

4. The portable digital display device as claimed in claim 1, wherein the first interface comprises a unidirectional image interface, as a bidirectional wired communication interface, a bidirectional wireless communication interface, and/or a near field communication standard.

5. The portable digital display device as claimed in claim 1, wherein the second interface comprises a USB interface.

6. The portable digital display device as claimed in claim 1, wherein:
the display comprises e-paper and
transition from the first state to the second state includes rolling and/or folding the e-paper.

7. The portable digital display device as claimed in claim 1, wherein:
the first module recognizes handwritten and/or spoken words;
upon recognition of semantic contents, converts the contents into a digital datum displayable a text format; and
upon nonrecognition of semantic contents, coverts the contents into a digital datum interpreted as a graphic input and displayable as an image.

8. The portable digital display device as claimed in claim 1, wherein the first module carries out the control of the display device so:
a) it is made capable of recognizing at least one control character from detected semantic contents,
b) it detects inputs marked by the at least one control character as a command and/or selection, and
c) it carries out at least one state change assigned to the command or the selection of at least parts of the display device and/or displayed content.

9. The portable digital display device as claimed in claim 1, further comprising a third interface, to present wirelessly transmitted electromagnetic as an interpretable movement incident within the display area of a remote signal source to the first module for recognizing semantic contents.

10-11. (canceled)
